(19) United States
(12) Patent Application Publication
(10) Pub. No.: US 2019/0216220 A1
(43) Pub. Date: Jul. 18, 2019

(54) MOTOR ASSEMBLY FOR CONVERTING RECLINING FURNITURE TO POWERED MODE

(71) Applicant: BILLY JOE GRIGGS, JR., PULASKI, TN (US)

(72) Inventor: BILLY JOE GRIGGS, JR., PULASKI, TN (US)

(21) Appl. No.: 16/129,947

(22) Filed: Sep. 13, 2018

Related U.S. Application Data
(63) Continuation-in-part of application No. 15/063,545, filed on Mar. 8, 2016.
Application No. 15/063,545 is a continuation of application No. 14/609,390, filed on Jan. 29, 2015, now Pat. No. 9,277,823.
(60) Provisional application No. 61/932,952, filed on Jan. 29, 2014.
(60) Provisional application No. 62/558,226, filed on Sep. 13, 2017.

(51) Int. Cl. A47C 1/024; A47C 1/032; A47C 7/00; A47C 1/0355; F16H 25/20

(52) U.S. Cl. CPC A47C 1/0242; A47C 1/03222; A47C 7/00; A47C 1/0355; F16H 2025/204; A47C 1/03211; Y10T 74/20; Y10T 74/18568; F16H 25/20

(57) ABSTRACT

A motor assembly for reclining furniture includes a motor having one or more first fittings that correspond to one or more second fittings within a reclining furniture actuation mechanism. The first and second fittings are configured to be mutually connectable without tools or fasteners. Linkage members are pivotally connected at one end to a moveable trolley, and at a second end through a bracket to a transverse drive tube in the actuation mechanism, so that movement of the trolley causes the transverse drive tube to rotate.

This application is a continuation-in-part of U.S. patent application Ser. No. 15/063,545, filed Mar. 8, 2016, which is a continuation of U.S. patent application Ser. No. 14/609,390, filed Jan. 29, 2015, which claims benefit of and priority to U.S. Provisional Application No. 61/832,952, filed Jan. 29, 2014, by Billy Joe Griggs Jr., and is entitled to those filing dates for priority. This application also claims benefit of and priority to U.S. Provisional Application No. 62/558,226, filed Sep. 13, 2017, by Billy Joe Griggs Jr., which is incorporated herein in its entirety by specific reference for all purposes.

This application incorporates in their entireties by specific reference the complete disclosures of co-pending U.S. patent application Ser. No. 15/063,545, filed Mar. 8, 2016, and U.S. patent application Ser. No. 14/609,390, filed Jan. 29, 2015, and U.S. Provisional Application No. 61/832,952, filed Jan. 29, 2014, by Billy Joe Griggs Jr.

### FIELD OF INVENTION

This invention relates generally to motor assemblies for reclining furniture, and particularly to motor assemblies which may be installed in reclining furniture without the use of tools or externally applied fasteners.

### BACKGROUND OF THE INVENTION

Recliner chairs and sofas are popular furniture pieces found in many living rooms across the country, as they can provide a level of comfort and relaxation that is considered unmatched by traditional chairs and sofas by many users. Over the past several years, recliner chairs and sofas have continued to evolve towards larger and heavier models that provide greater cushioning and space for their occupants, often resulting in more complex and robust recliner mechanisms and frames needed to support and carry the additional weight. However, While the exterior and visible portions of reclining furniture continues to change, the underlying recliner mechanisms Which elevate and carry the various support panels (i.e. the seat rest, the back rest, the foot rest, etc.) continue to be divided into two basic types; manual actuation and powered actuation.

Manually-actuated recliners are the more popular of the two types of recliners, primarily for cost and simplicity reasons. The number of recliner models that are originally manufactured for powered actuation are often only available in limited models, styles and sizes, and typically cost several hundreds of dollars more that manually-actuated models. Consequently, most recliner models are originally manufactured for manual actuation. Even if the model, style and size of a particular manually-actuated recliner includes an option for powered actuation, special modifications must be made at the factory prior to assembly to make the piece suitable for powered actuation. As a result, many recliner models with power actuation often require special ordering and extended wait times to before the furniture can be delivered to the point of sale.

There are times, however, when a customer may change his or her mind after ordering a lower-cost manually actuated recliner, and Wish instead to purchase the same recliner with powered actuation, and preferably for the same cost differential. Even if available, however, this change in the sales order may still result in additional costs and significant delivery delays, which may prompt the customer to cancel the sale altogether and purchase from another supplier. In other cases, the end user may change his mind after taking delivery and using the recliner for a period of time, and then decide that powered actuation is a preferred option and worth the additional cost. However, since the reclining furniture piece has already been delivered, the time, effort and cost to ship the recliner back to the factory for retrofitting to powered actuation, in addition to the cost of the conversion itself, is prohibitive.

Moreover, retail sellers often must pre-order either manual or powered recliners, Where display floor space is limited. A customer may prefer a certain style that is only shown in manual configuration. Even if that style is available in a powered version (where often it is not), the customer is forced to wait two to three months for an eventual delivery. Such a delay can lead to customer frustration at the least and a lost sale at the worst. The retail seller lacks a method of converting on-site a manual recliner to a powered recliner.

Accordingly, it can be seen that a need exists for a method and apparatus for converting a recliner from manual actuation to powered actuation at a field or point-of-sale location that addresses the foregoing and various other related and unrelated problems in the art.

### SUMMARY OF INVENTION

In various embodiments, the present invention comprises a motor assembly for use in typical motorized reclining furniture. A motor along with a gear box is mounted to one end of a slide rail such the motor drives a screw. A trolley is slidably engaged with the slide rail and threadably engaged with the screw such that rotation of the screw in either direction causes the trolley to move along the slide rail in either direction. The motor assembly is also equipped with a cap at the opposite end of the slide rail.

Additionally, a clevis extends from the gear box housing to permit connection to the recliner mechanism as will be described in detail below.

A first embodiment of the motor assembly is shown in which it the assembly is attached to a base frame. This embodiment is particularly suited for use with reclining furniture that maintains a certain distance from a wall when actuated, known in the industry as a “wall-away”. It can be seen the motor assembly is seated within the frame which is formed from two side rails and two end rails.

Either end of the motor assembly is seated on opposing end rails. In this embodiment, the motor assembly includes a first fitting piece extending from the gear box housing. The fitting comprises one or more prongs or bosses that extend axially outward, and are dimensioned to be received within one or more openings defined within a wall of the end rail.

At the opposite end of the slide rail, the cap may be configured with a boss having a flange and extending downward that is dimensioned to be received in an opening defined in a horizontal portion of the end rail. The boss is of a height to extend through the opening and below the lower surface of the rail. A slide having keyhole-type opening defined therethrough comprising a large portion and a small portion. The large portion is dimensioned to be placed over the flange of the boss as it extends beyond the bottom surface of the rail. The small portion is dimensioned to be smaller than the dimensions of the flange such that the slide. Once the boss is inserted through the large portion of the slide opening, the slide is moved so that the small portion of the opening surrounds the boss, thus retaining the cap against the rail.

In a further embodiment, the motor assembly comprises a transverse linkage member fixedly attached to the trolley. Opposing recliner mechanisms comprise an inward extending female fitting that is dimensioned to receive the end of transverse linkage member and may be configured with a spring pin latching arrangement. In this embodiment, a second transverse linkage bar is hingedly connected to the clevis of the gear box housing. The recliner mechanism may also include a male fitting that is received in a female fitting in each end of the second transverse linkage bar. Again, the respective fittings may include a spring pin latching arrangement. Thus configured, the motor assembly may be easily and quickly installed in a recliner by simply fitting the connections in place without tools or extraneous fasteners.

### BRIEF DESCRIPTION OF THE DRAWINGS

FIGS. 1A & B depict an exemplary recliner motor assembly.

FIG. 2 shows one exemplary embodiment of a motor assembly configured for installation in a recliner.

FIGS. 3A & B show exemplary fittings for the motor assembly gear box housing and base frame.

FIGS. 4A & B illustrate a manner by which to seat the motor assembly of FIG. 2 in a base frame.

FIG. 4C show another example of fitting for connecting the motor assembly to the base frame.

FIGS. 5A through D depict one exemplary configuration for connection an end of the motor assembly to the base frame.

FIGS. 6A & B depict how the motor assembly of FIG. 2 is fitted with a recliner actuation mechanism.

FIGS. 7A & B provide one exemplary method for connecting a transverse linkage member to the motor assembly.

FIG. 8 shows another embodiment of a motor assembly.

FIGS. 9 & 9A illustrate the connections between the motor assembly of FIG. 8 and recliner actuation mechanisms for a rocker recliner.

FIGS. 10-26B show various forms of mounting plates.

FIGS. 27A-30 show a clamshell attachment bracket for attaching two swing arms to a drive tube or transverse linkage member.

FIGS. 31A-32D show attachment brackets with a movable securing bolt.

FIGS. 33A-34 show a clamshell attachment bracket with bracket supports extending from the ends.

FIGS. 35A-35B shows a form of dual clamshell attachment bracket.

### DETAILED DESCRIPTION OF EXEMPLARY EMBODIMENTS

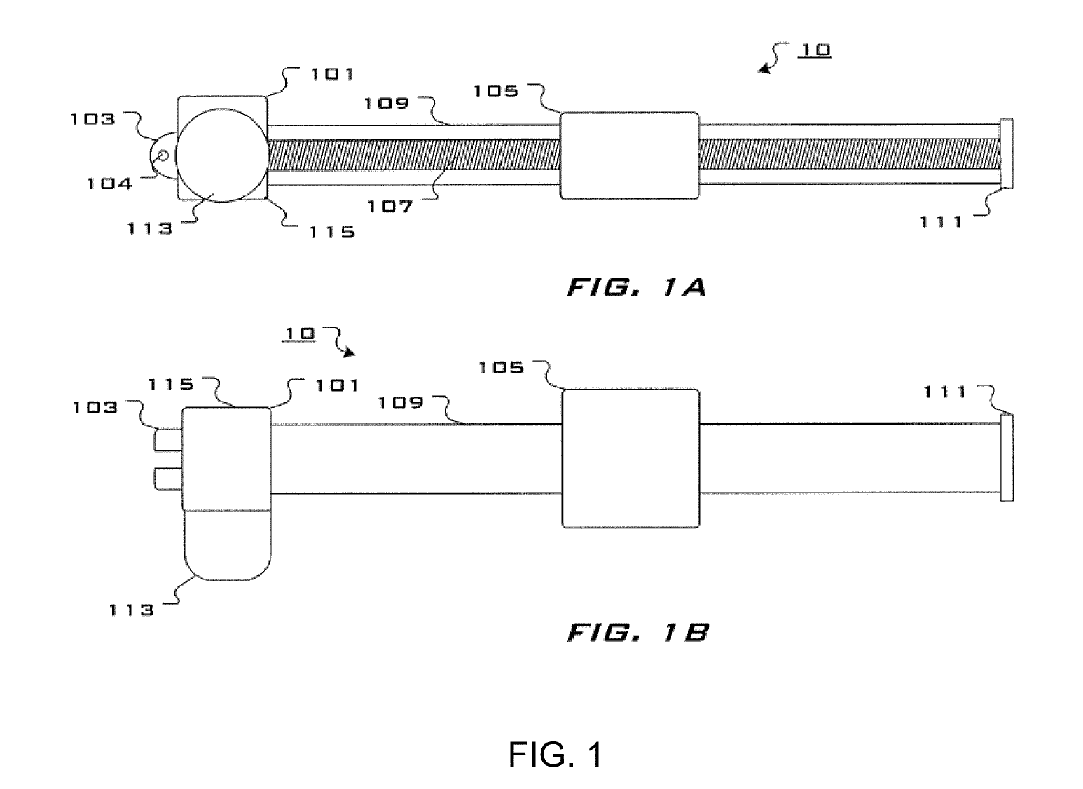

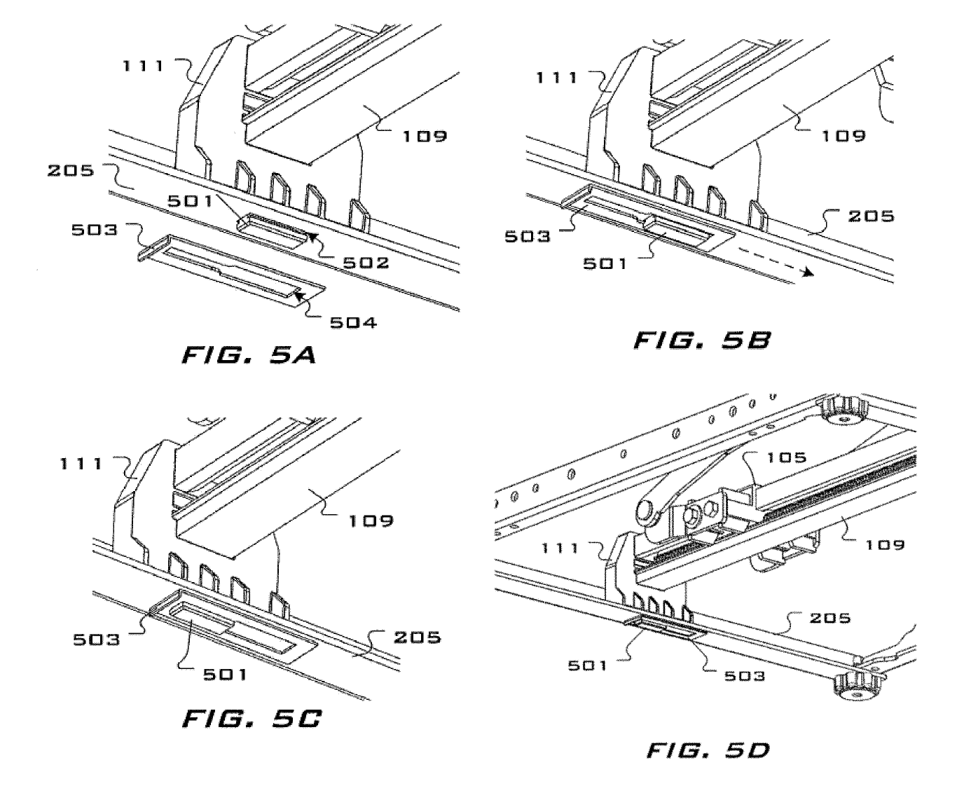

The various embodiments of the motor assembly for reclining furniture and their advantages are best understood by referring to FIGS. 1 through 9A of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

FIGS. 1A-B depict a motor assembly 10 for use in typical motorized reclining furniture. A motor 113, along with a gear box 115 is mounted to one end of a slide rail 109 such the motor 113 drives a screw 107. A trolley 105 is slidably engaged with the slide rail 109 and threadably engaged with the screw 107 such that rotation of the screw 107 in either direction causes the trolley to move along the slide rail 109 in either direction. The motor assembly 10 is also equipped with a cap 111 at the opposite end of the slide rail 109. Additionally, a clevis 103 extends from the gear box housing 115 to permit connection to the recliner mechanism as will be described in detail below.

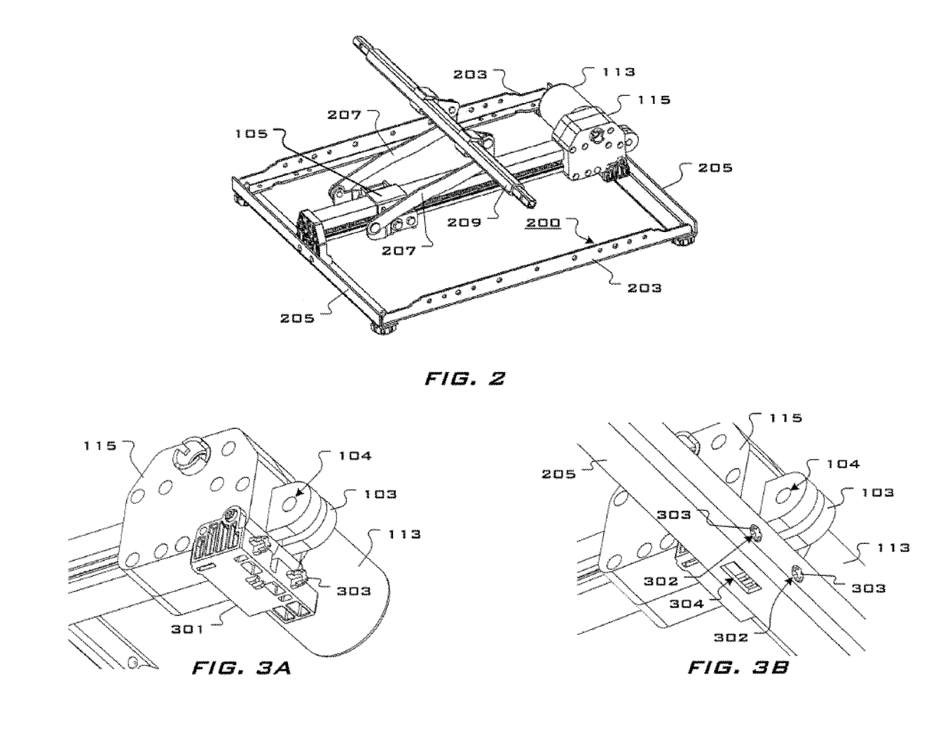

With reference to FIG. 2, a first embodiment of the motor assembly 10 is shown in which it the assembly is attached to a base frame 200. This embodiment is particularly suited for use with reclining furniture that maintains a certain distance from a wall when actuated, known in the industry as a “wall-away”. It can be seen the motor assembly 10 is seated within the frame 200 which is formed from two side rails 203 and two end rails 205.

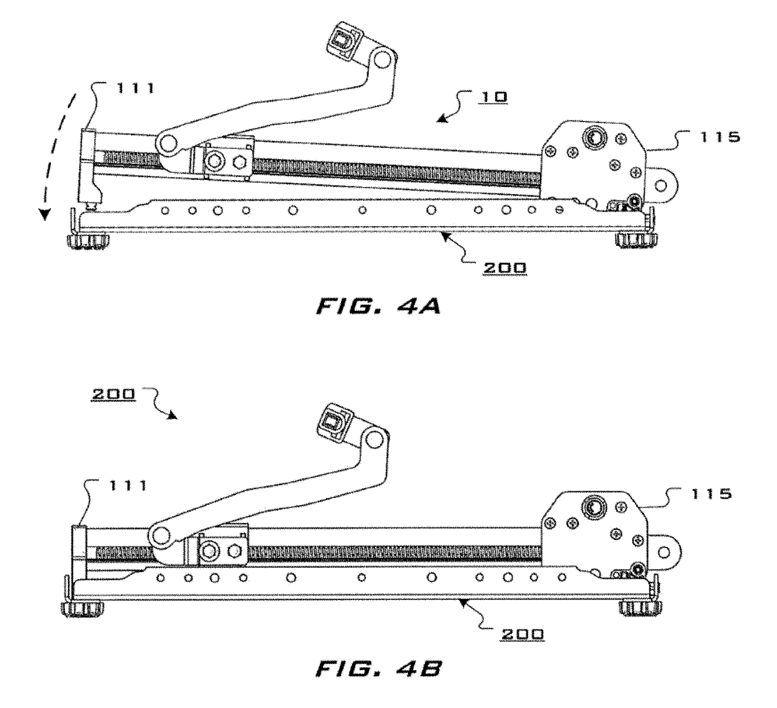

With reference to FIGS. 3A-B, and 5A-D, either end of the motor assembly 10 is seated on opposing end rails 205. In this embodiment, the motor assembly 10 includes a first fitting piece 301 extending from the gear box housing 115. The fitting 301 comprises one or more prongs 303 or bosses that extend axially outward, and are dimensioned to be received within one or more openings 302, 304 defined within a wall of the end rail 205.

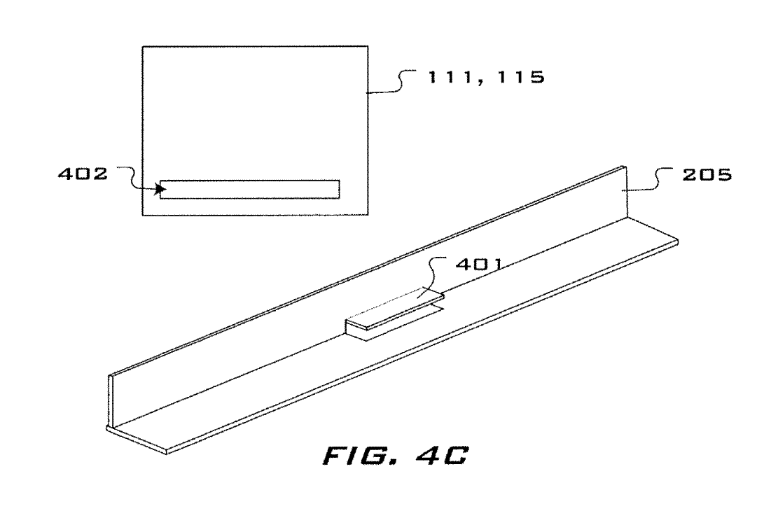

At the opposite end of the slide rail 109, the cap 111 may be configured with a boss 501 having a flange and extending downward that is dimensioned to be received in an opening 502 defined in a horizontal portion of the end rail 205. The boss is of a height to extend through the opening 504 and below the lower surface of the rail 205. A slide 503 having keyhole-type opening 504 is defined therethrough comprising a large portion and a small portion. The large portion is dimensioned to be placed over the flange of the boss 501 as it extends beyond the bottom surface of the rail 205. The small portion is dimensioned to be smaller than the dimensions of the flange such that once the boss 501 is inserted through the large portion of the slide opening 504, the slide 503 is moved so that the small portion of the opening surrounds the boss 501, thus retaining the cap 111 against the rail 205. FIGS. 4A-B simply illustrate the manner of inserting the motor assembly 10 into the base frame 200 where the gear box housing 115 is place on its end rail 205 with the prong(s) 303 inserted into their respective openings 302 in the rail 205. Then, the opposite end of the assembly 10 may be lowered into place with the end cap 111 seated against its rail 205 as described above.

FIG. 4C illustrates an alternative configuration for the cap 111 and the gear box housing 115 to connect to the end rails 205. In this embodiment, the end rails 205 are configured with an inward extending tab 401. The cap 111 and the gear box housing 115 are formed with a slot that receives the tab 401 and holds the motor assembly 10 against the base frame.

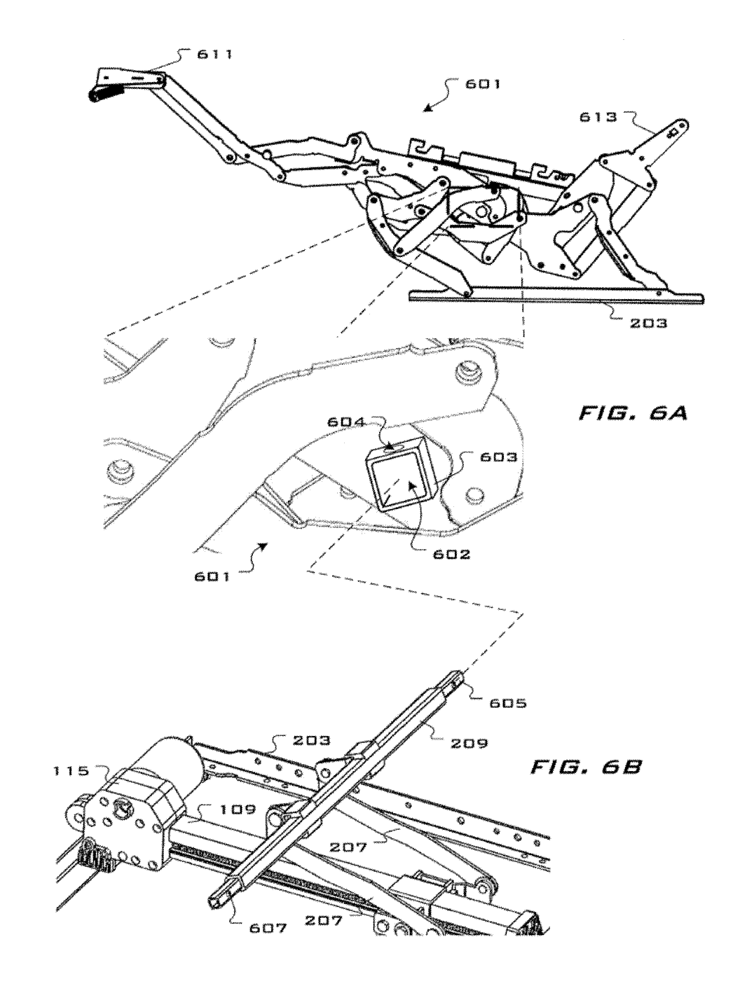

Returning to FIG. 2, the trolley 105 in this embodiment is pivotally coupled to respective ends of a pair of swing arms 207. The opposite ends of the swing arms 207 are connected to a transverse, elongated linkage member 209. FIGS. 6A-B show this embodiment in relation to a recliner actuation mechanism 601, which itself is connected to the base frame 200. It will be appreciated that although only one mechanism is shown, reclining furniture is typically configured with a pair of opposing mechanisms. Accordingly, the following description of the fittings and connections between the motor assembly 10 and the mechanism 601 will apply to both mechanisms.

Recliner mechanism 601 typically includes a footrest attachment flange 611 for supporting a footrest (not shown) and a seat back attachment bracket 613. Recliner mechanism 601 may be configured with a female fitting 603 that is dimensioned to receive a male fitting 605 extending from the end of the transverse linkage member 209. In order to secure the connection, the male fitting 605 may be configured with a spring pin 607 biased away from the male member 605. The female fitting 603 includes a detente 604 through which the spring pin 607 may extend. As such, when the male fitting 605 is inserted into the female fitting 603, the spring pin 607 is urged toward the interior of the fitting. When the male fitting is inserted far enough, the spring pin meets the opening 604 and is free to extend outward, latching the male fitting within the female fitting 603.

Accordingly, it will be appreciated that the motor assembly 10, thus configured, may be installed by simply fitting the assembly into place. Also, the assembly 10 may be easily removed from the recliner as well by unfitting the connections by hand. In this way, a recliner may be easily converted from a manually actuated recliner to a power actuated recliner without tools, or extraneous fasteners.

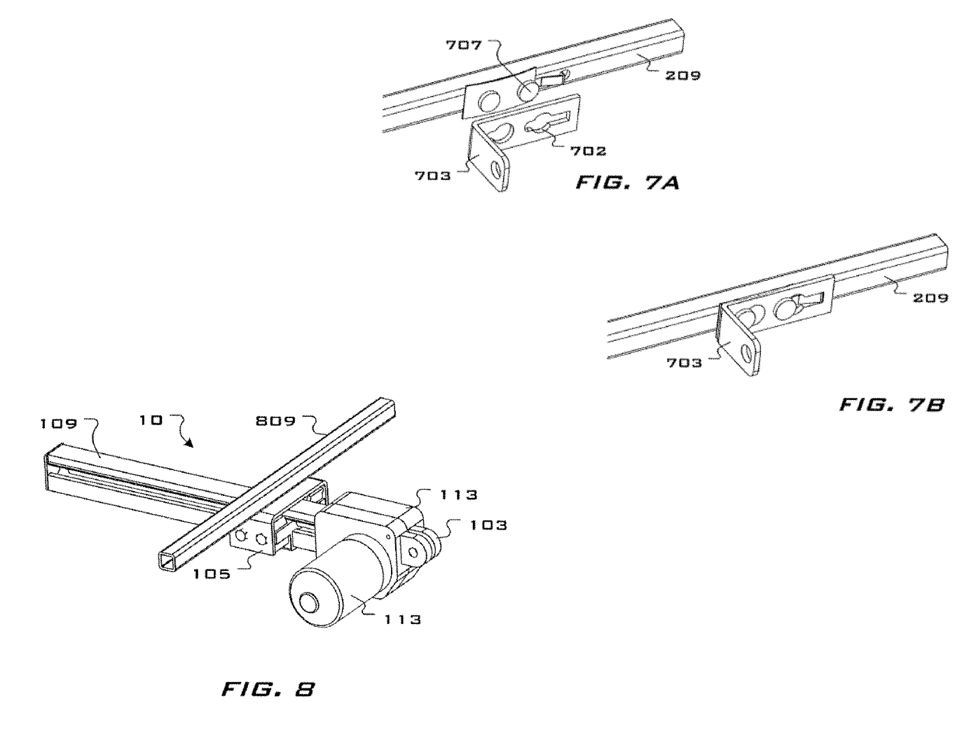

Turning now to FIGS. 7A-B, an exemplary arrangement is shown for connecting the swing arm 207 to the transverse linkage member 209. An attachment bracket 703 is pivotally connected to the end of each swing arm 207 and includes one or more openings 702 defined in a flange that correspond to one or more rivets 707 extending from the transverse linkage member 209. The openings 702 receive the rivets 707 that include a circular flange that retain the bracket against the linkage member 209.

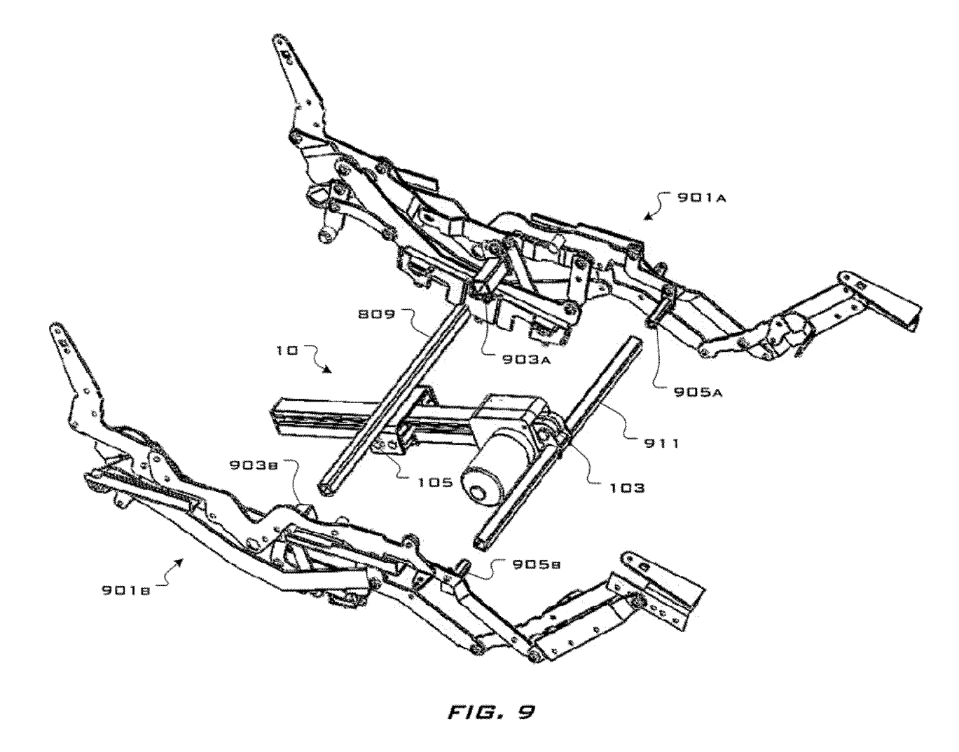

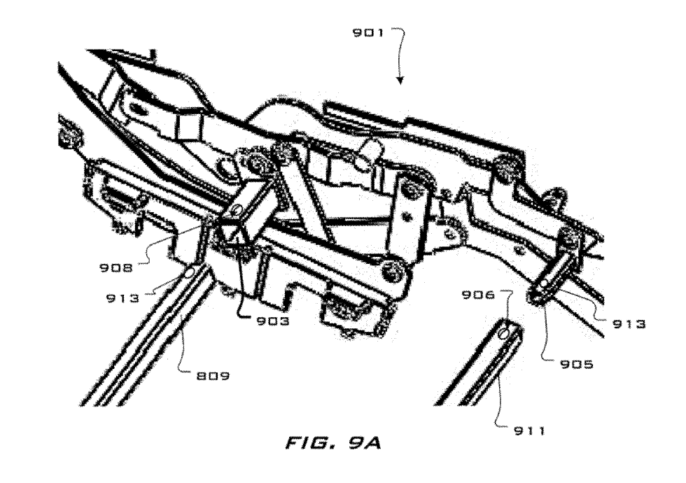

A further embodiment is illustrated in FIGS. 8 through 9A, where motor assembly 10 comprises a transverse linkage member 809 fixedly attached to the trolley 105. As shown in FIG. 9, opposing recliner mechanisms 901a, b are configured for a rocker recliner, to be attached to a rocker base (not shown). Each mechanism 901 comprises an inward extending female fitting 903a, b that is dimensioned to receive the end of transverse linkage member 809 and may be configured with a spring pin latching arrangement as described above and as shown in FIG. 9A. In this embodiment, a second transverse linkage bar 911 is hingedly connected to the clevis 103 of the gear box housing 115. The recliner mechanism 901a, b may also include a male fitting 905a, b that is received in a female fitting in each end of the second transverse linkage bar 911. Again, the respective fittings may include a spring pin latching arrangement as shown in FIG. 9A. Again, thus configured, the motor assembly may be easily and quickly installed in a recliner by simply fitting the connections in place without tools or extraneous fasteners.

In a further embodiment, the motor and/or gear box are mounted on the trolley, or integrated therewith, and thus move along the slide rail, which is attached at one or both ends as described above. In another embodiment, the slide rail is moved longitudinally by action of the motor, with the trolley fixed to the slide rail.

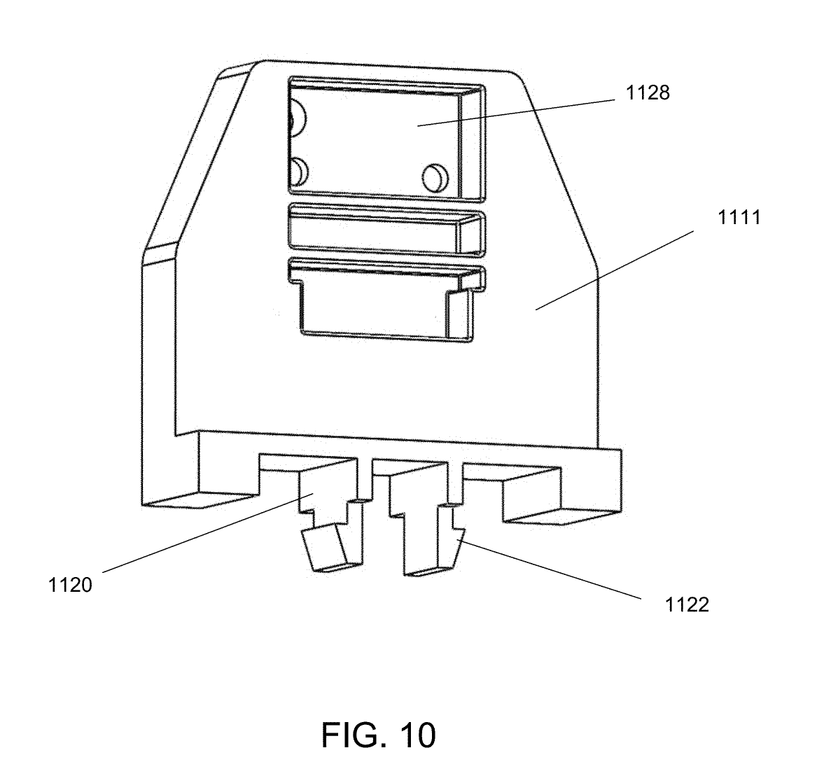

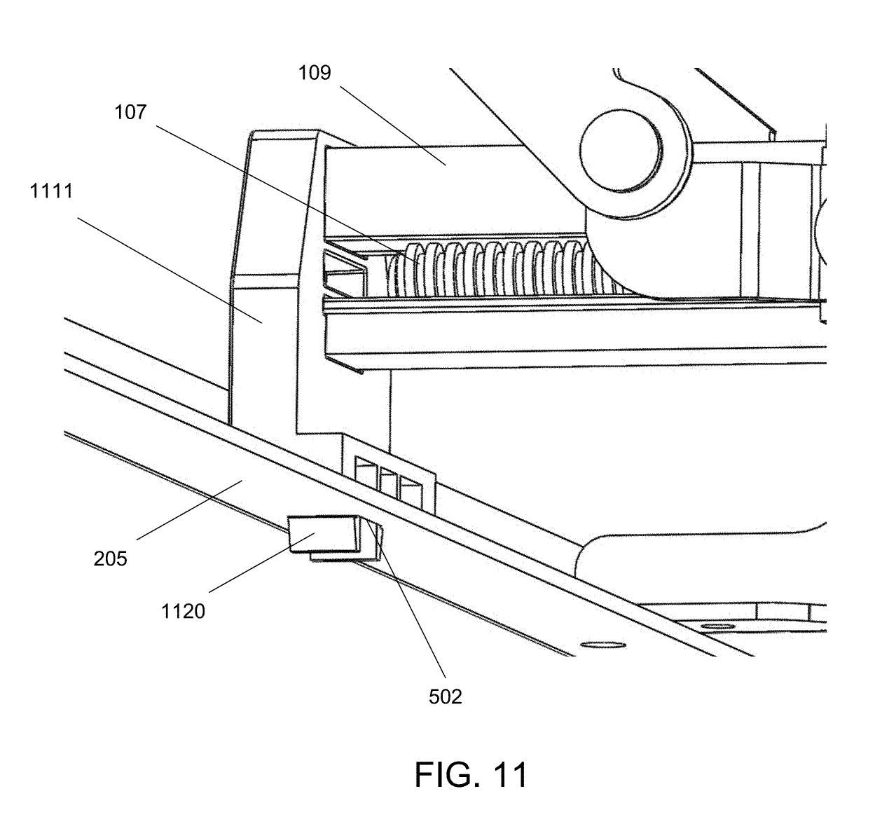

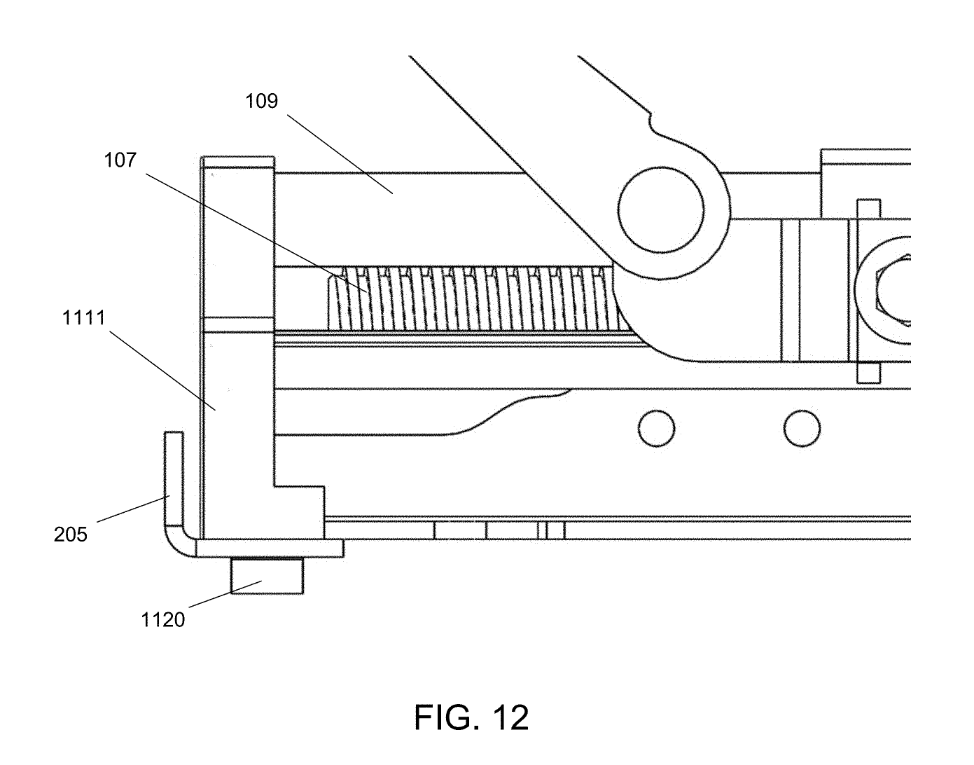

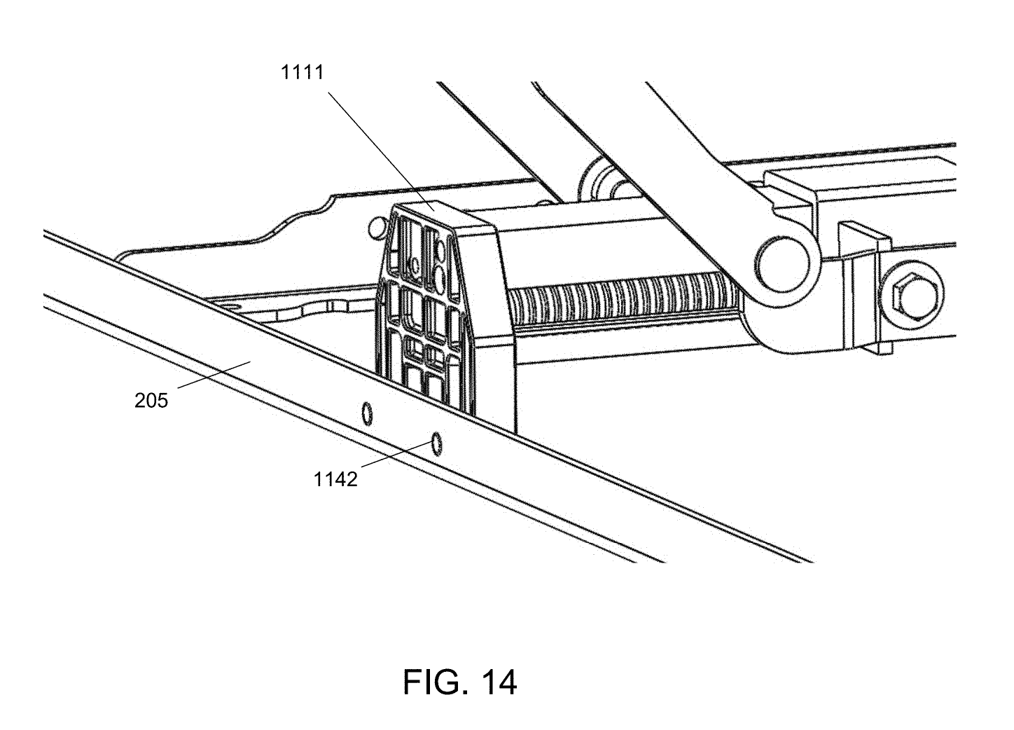

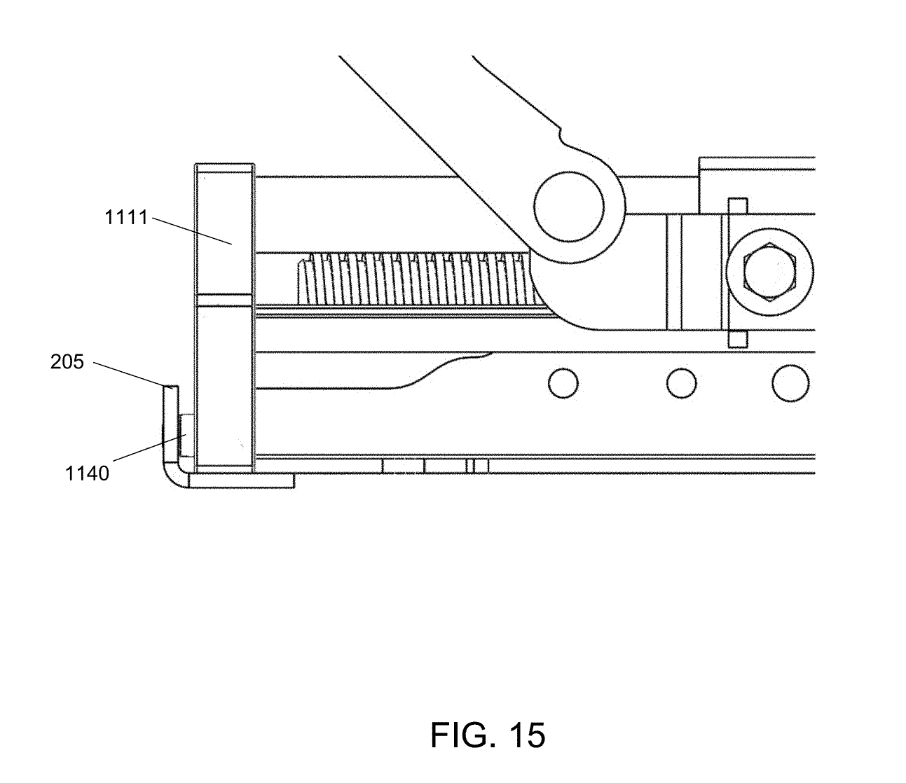

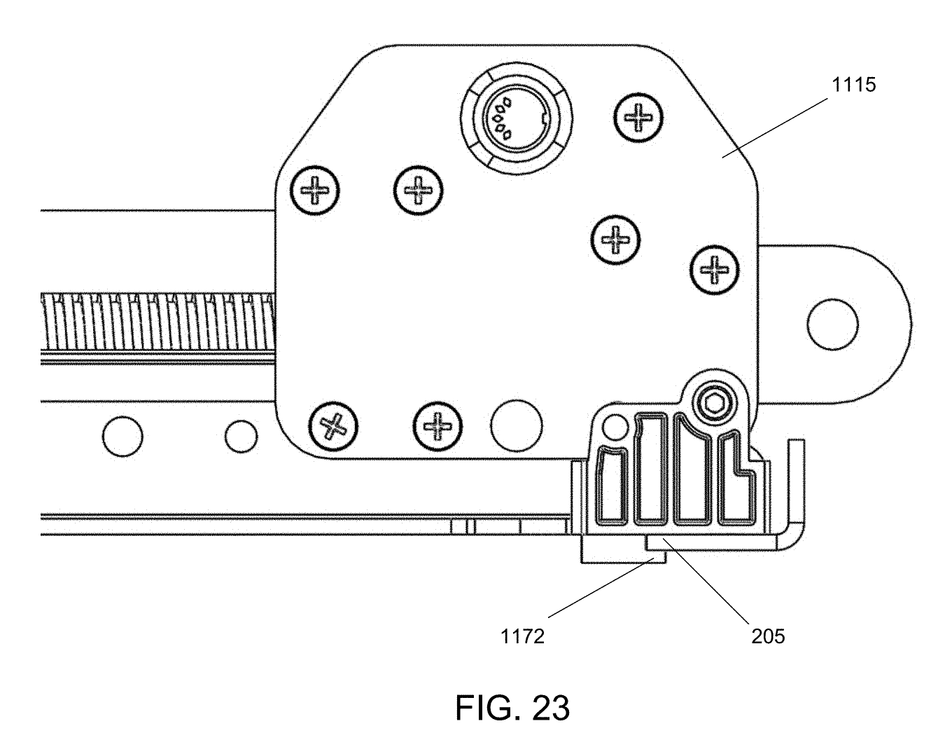

In further embodiments, one or both ends of the slide rail, or motor or gear-box, may be attached to the base frame by improved connection means, as seen in FIGS. 10-28.

FIGS. 10-12 shows an embodiment of an end-cap or vertical connection plate 1111 with one or more latching tabs or prongs 1120 on the bottom with horizontal catches 1122, which compress when being pushed into an opening or slot 502 on an end rail 205 of the base frame, and then spring into a locking position when fully inserted. One side of the vertical plate comprises receiving holes or spaces 1128 for mounting an end of the slide rail 109.

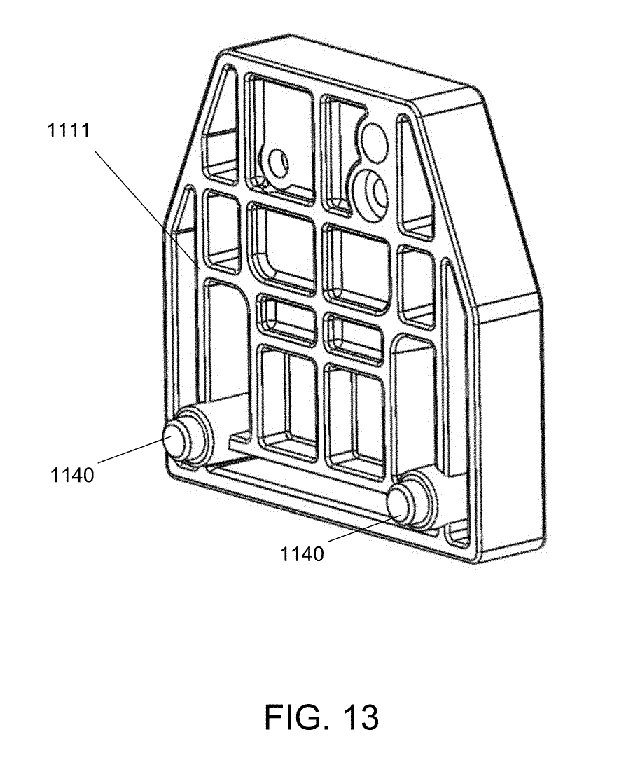

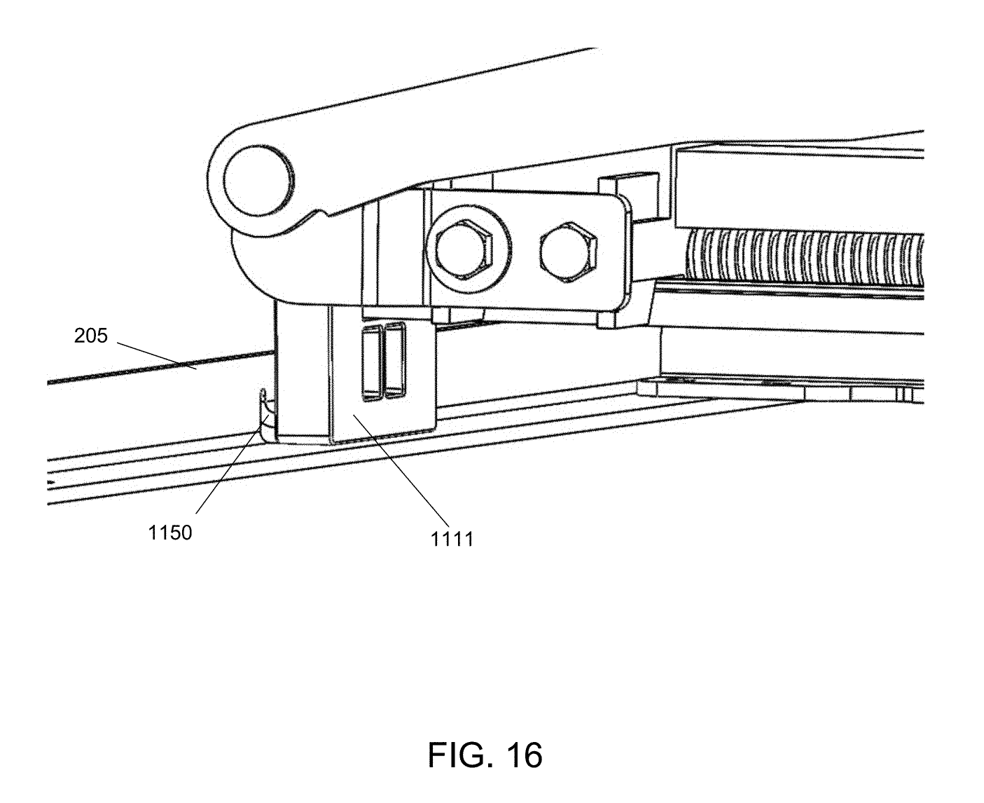

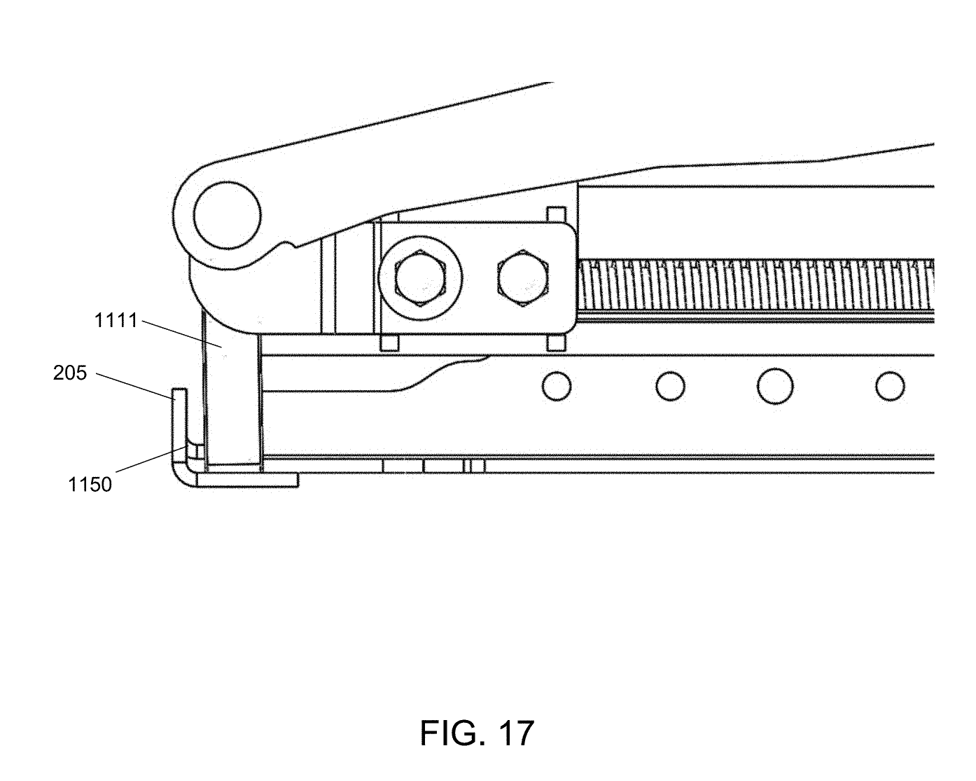

FIGS. 13-15 shows an alternative embodiment an end-cap or vertical connection plate 1111 with one or more prongs 1140 extending axially from the back thereof, configured to be inserted or received into corresponding holes or openings 1142 in a wall of the end rail 205. The one or more prongs may fixed in length, such as when this end of the slide rail is configured to be inserted first during installation. In an alternative embodiment, the center portion of each prong may be movable, such as with a spring that bias the center portion of the prong to an extended position, but can be pushed into a retracted position for insertion or removal (in a similar fashion to the spring pin described above). Similarly, FIGS. 16-17 show another embodiment of an end-cap or vertical connection plate with one or more curved tabs 1150 extending axially and upward from the back thereof, configured to be inserted into or engage a slot, hole or opening in the wall of the end rail 205.

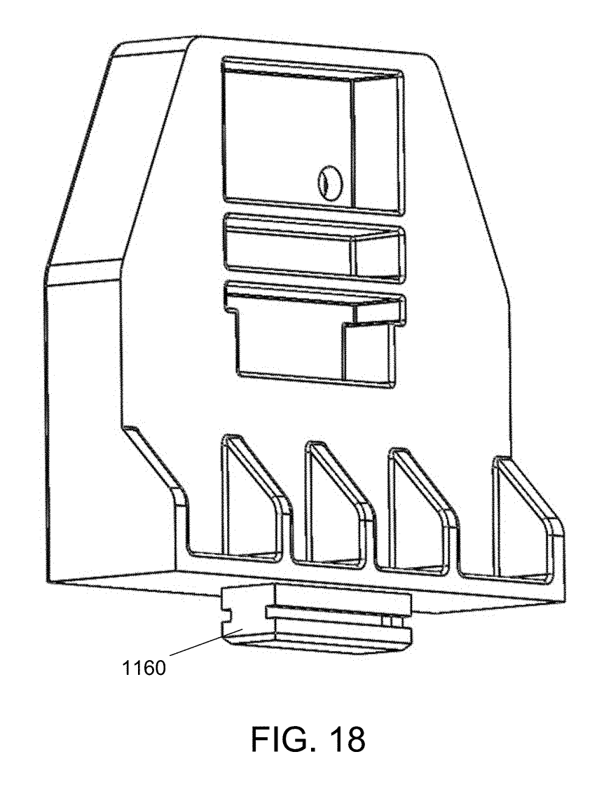

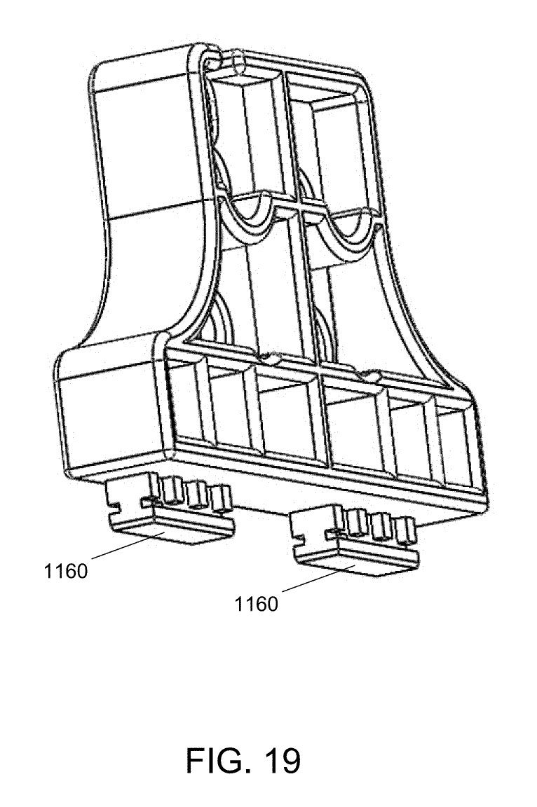

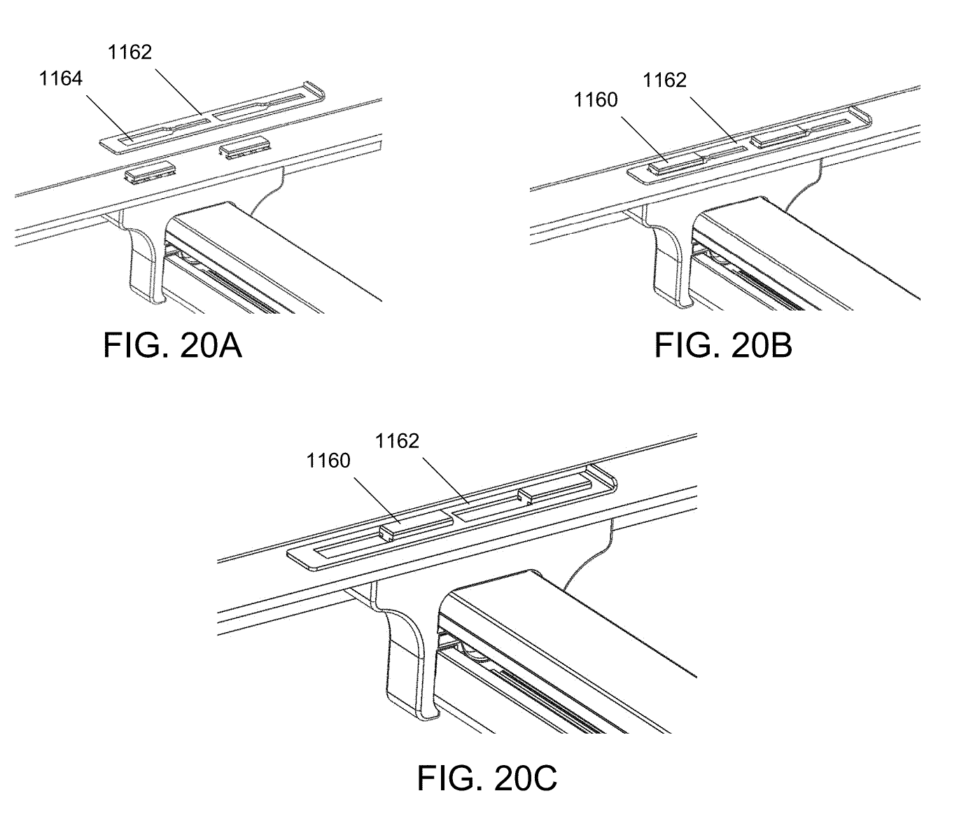

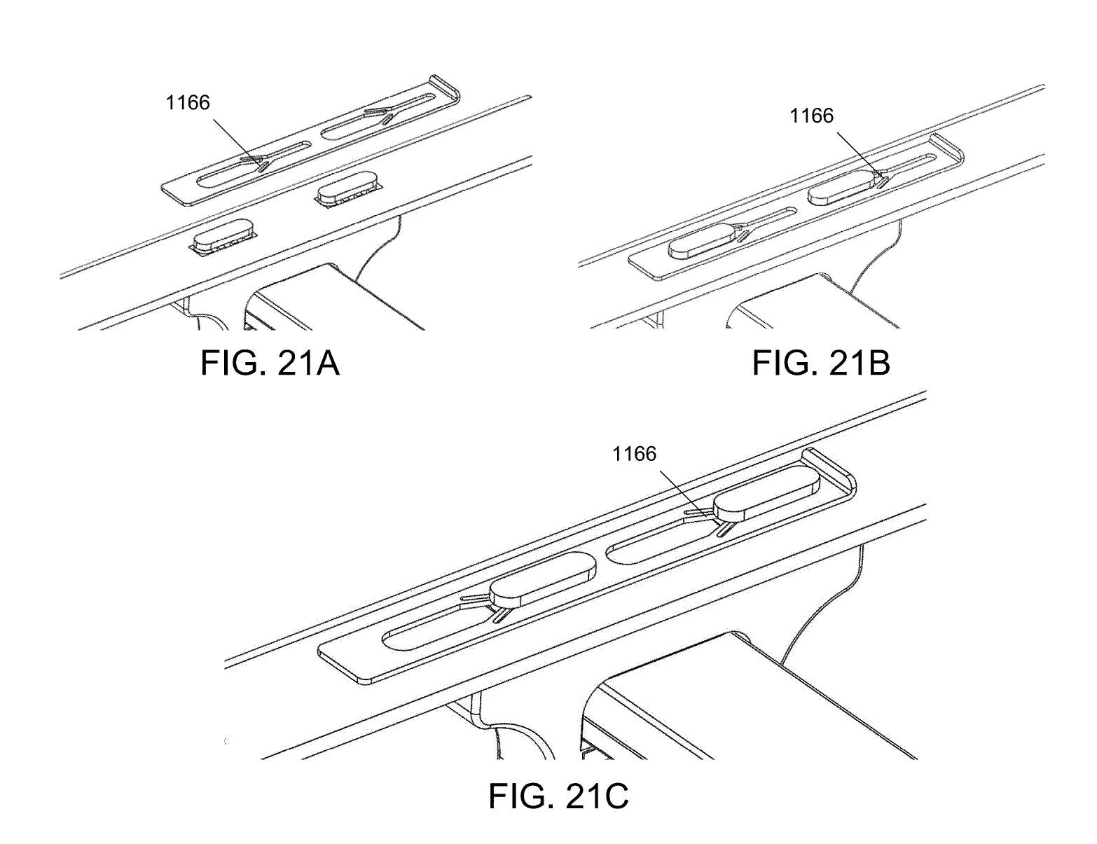

FIGS. 18-19 show alternative embodiment of an end-cap or vertical connection plate with one or two bosses 1160 extending from the bottom thereof. As discussed above, the bosses may be inserted into corresponding openings or holes in the end rail, with a sliding catch plate used to secure the boss or bosses. FIGS. 20A-C show a dual-boss sliding catch plate 1162 with two keyhole openings 1164 being used to engage and secure the bosses on the end-cap. FIGS. 21A-C show an improved two-opening sliding catch plate, with angled locking arms 1166 angled inward at the end of the wider section towards the narrow section of the keyhole opening, and adapted to spring inward and lock the bosses in place after being slid into place. The end of each locking arm extends inward far enough to engage the narrow “neck” of the boss, and prevent the catch plate from sliding back to a release position.

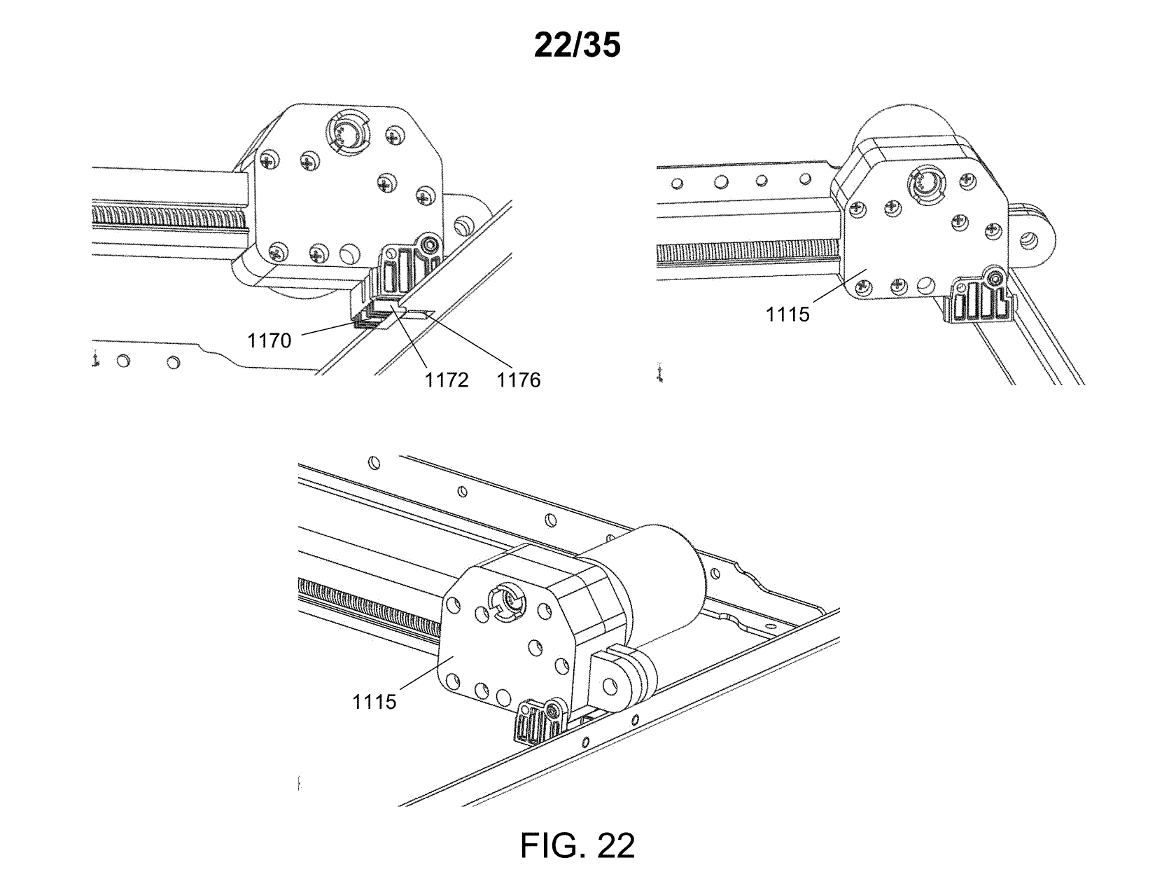

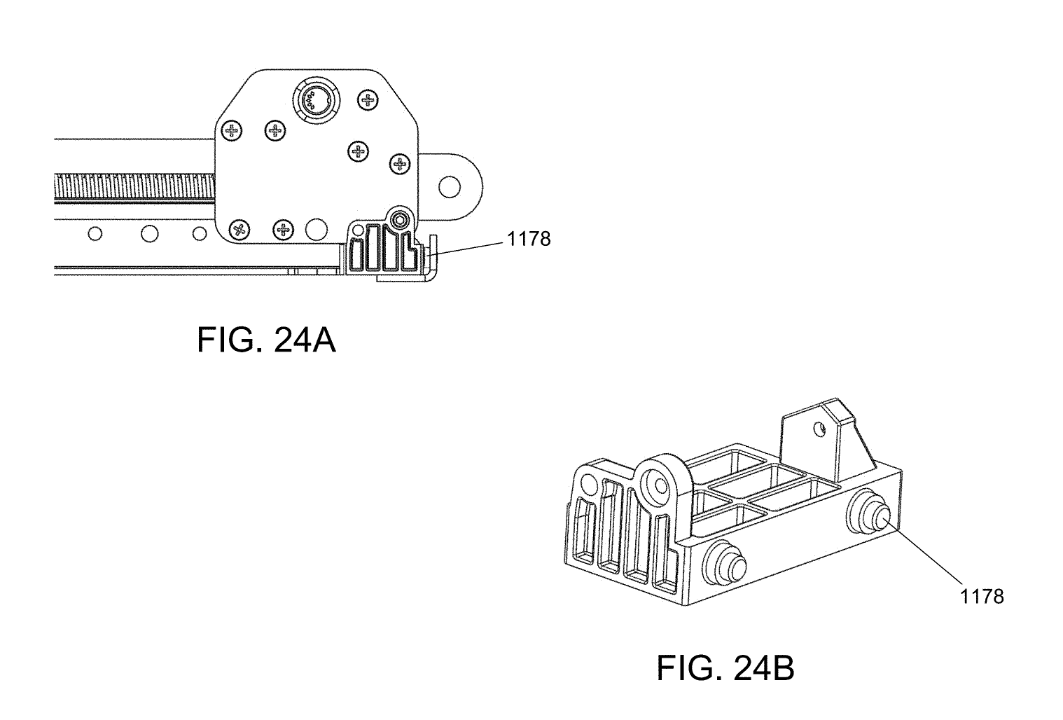

FIGS. 22A-C and 23 shows another form of improved connection means, integrated with the motor and gear-box 1115. A boss 1170 extends from the bottom of the motor/gear-box 1115, and the center of the boss is slidingly inserted into a slot 1176 in the end rail 205 of the base frame. The sides 1172 of the boss extend outward beyond the sides of the slot and a lip engages the edge of the end rail 205, and locks the end of the slide rail into place on the base frame without use of a separate slide or catch. FIGS. 24A-B show a mounting plate comprising a pair of tabs or prongs or posts 1178 for engaging corresponding holes or openings in the end rail.

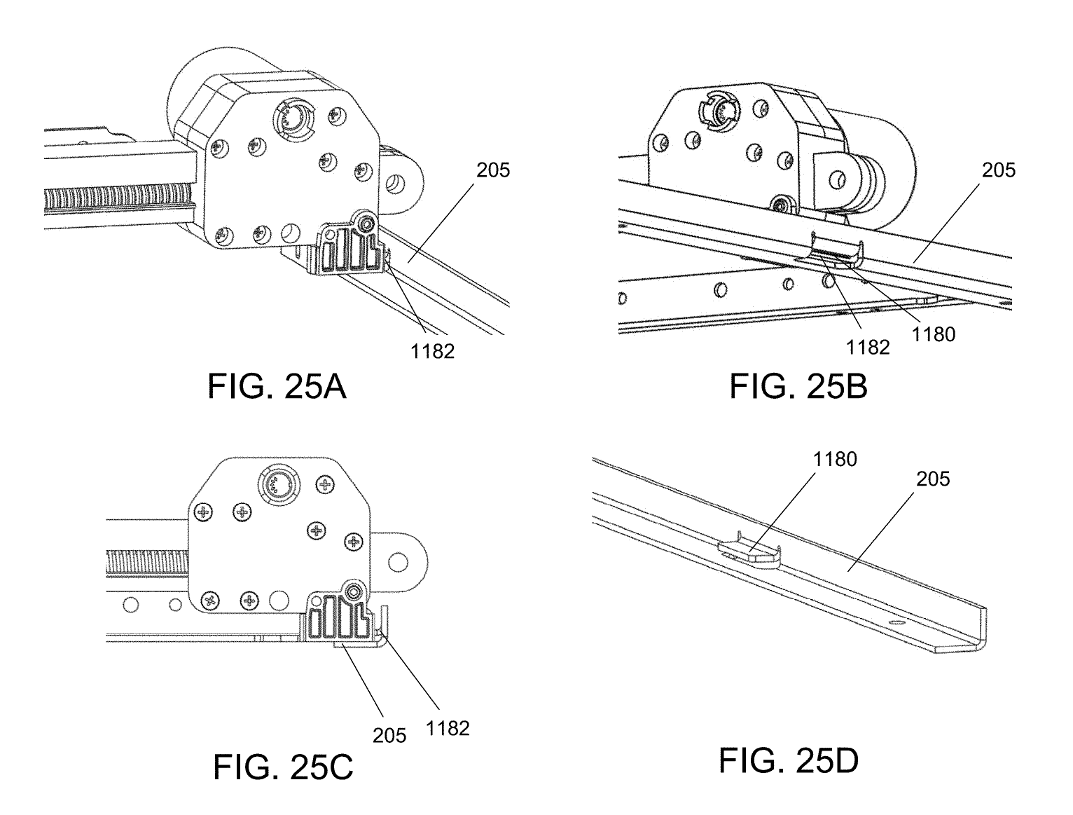

FIGS. 25A-D show a mounting plate with a hole or slot or lip 1182 adapted to engage a curve or raised tab 1180 extending axially from the inside of a wall of the end rail 205.

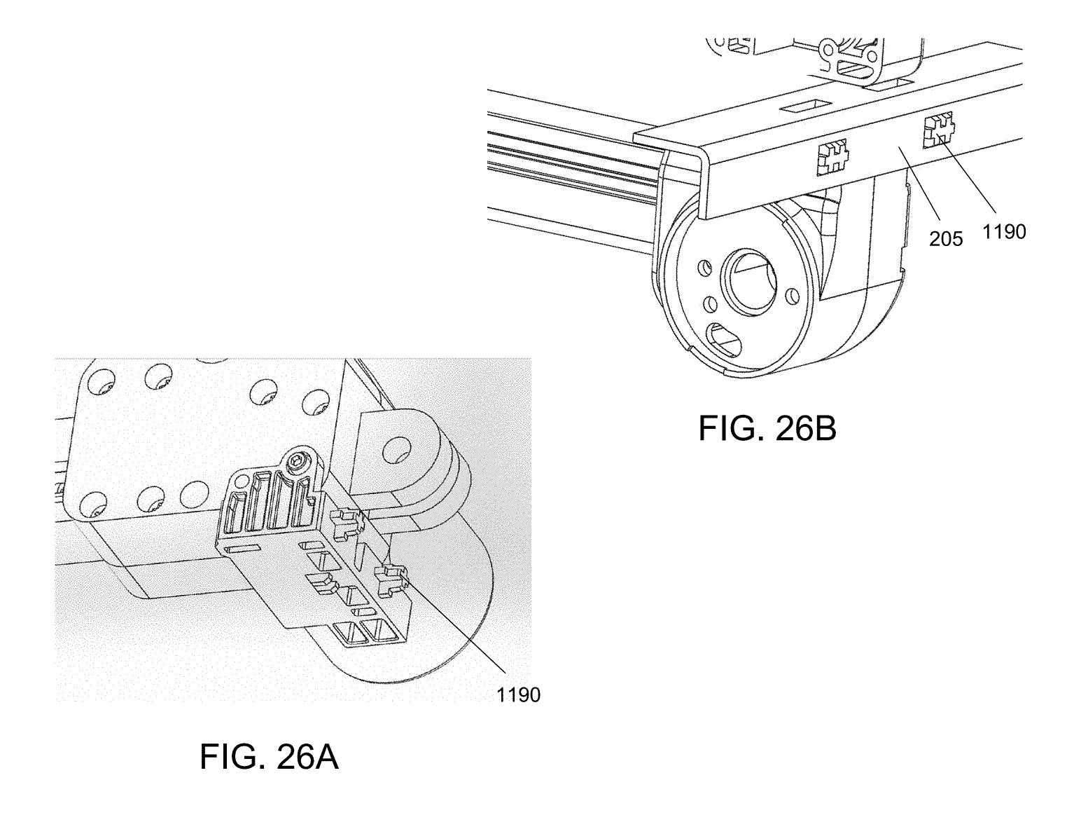

FIGS. 26A-B show additional forms of mounting plates with pairs of tabs or posts or prongs 1190 in geometric configuration with the outermost end being smaller in width or radius, with width or radius increasing closer to the base plate. This eases entry of the tab/post/prong into corresponding holes or openings in the end rail 205.

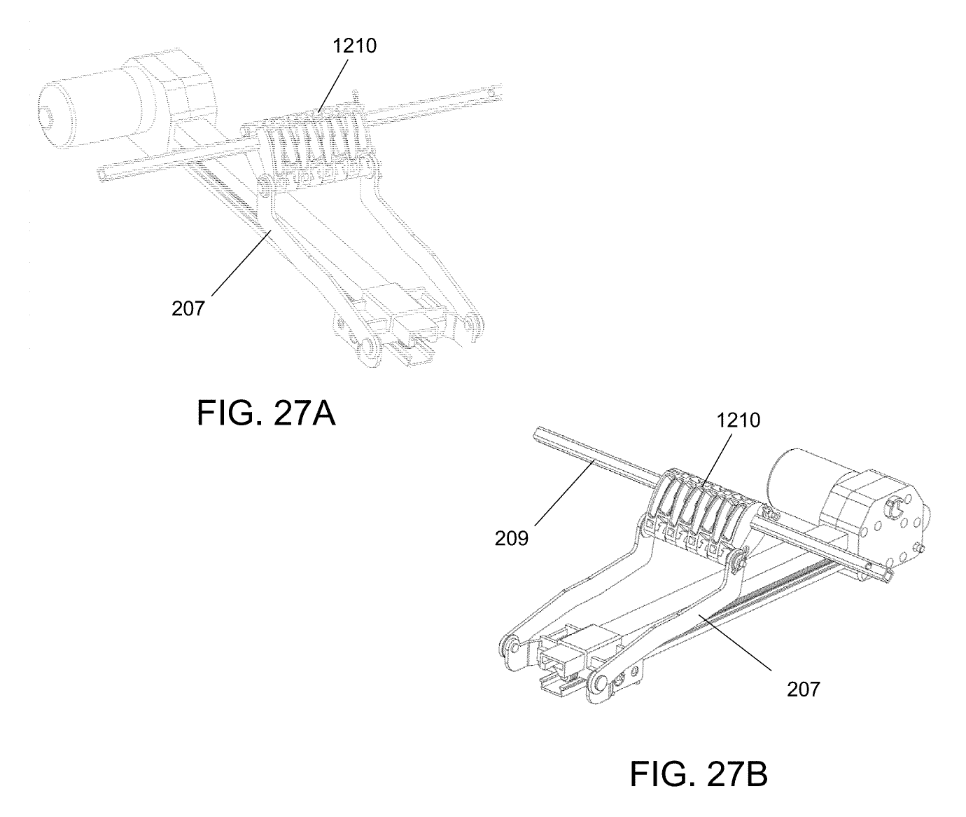

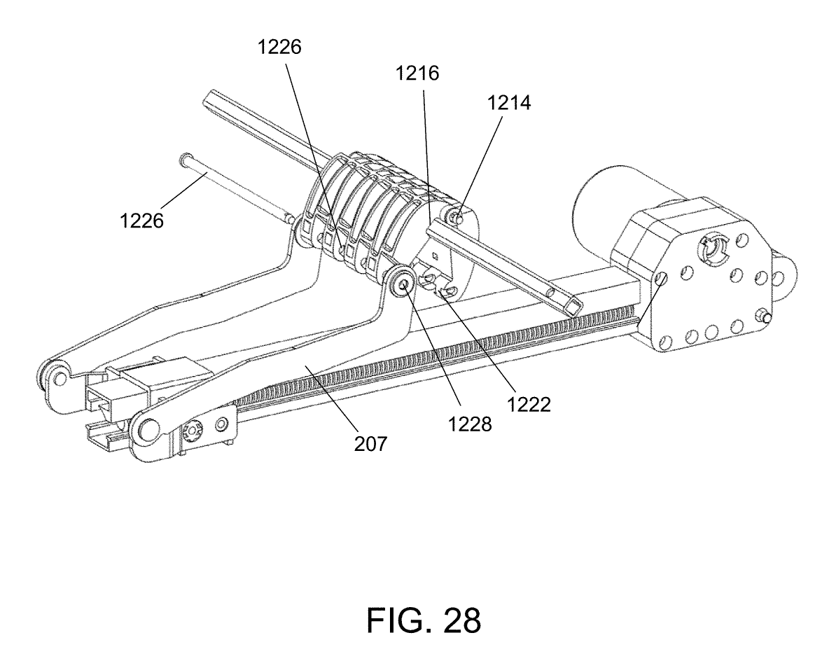

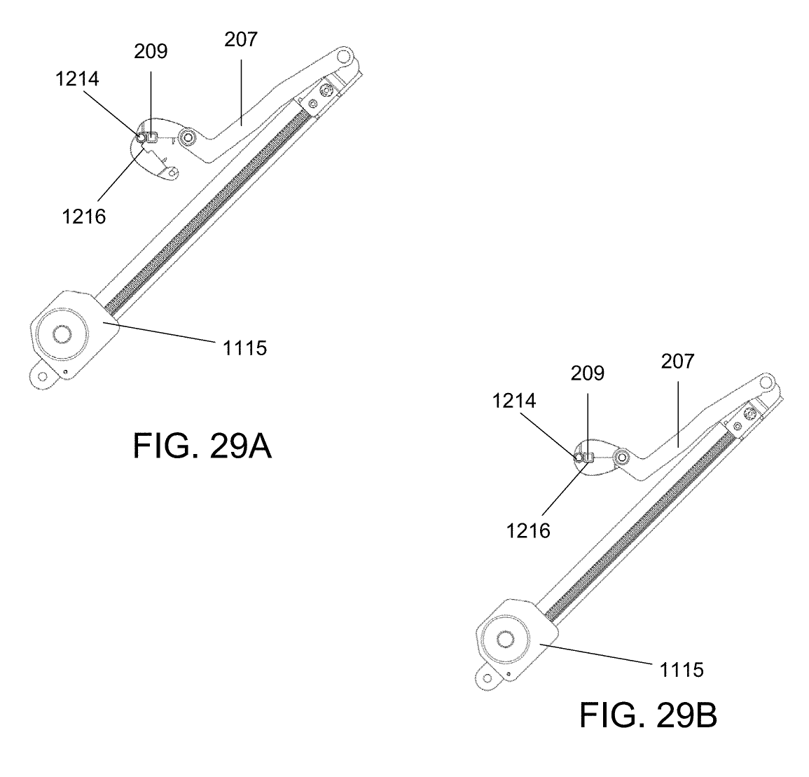

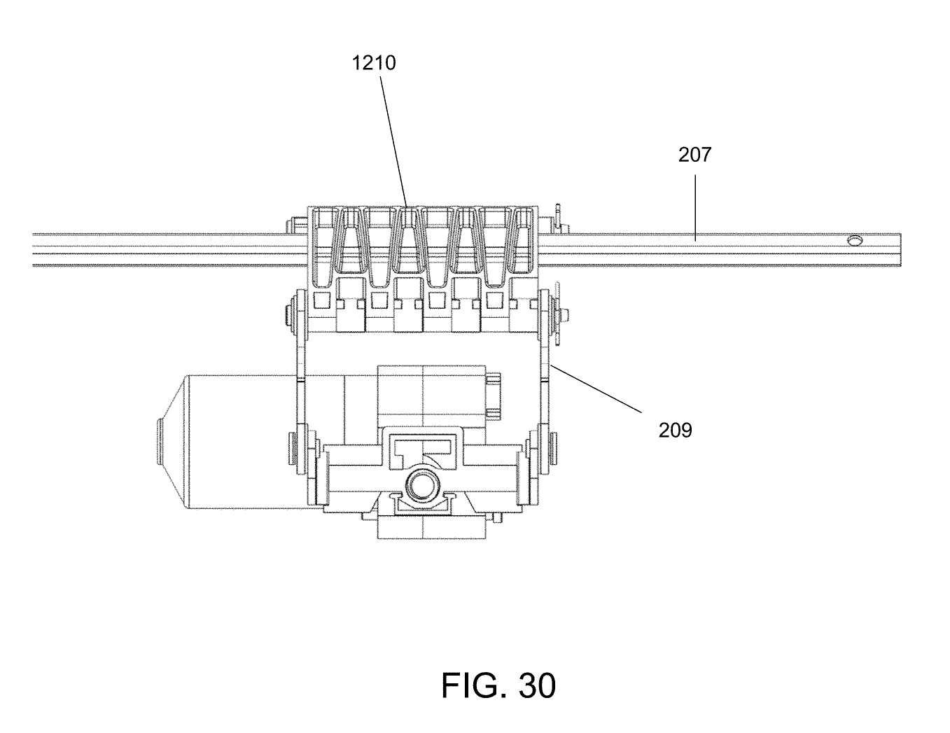

In further embodiments, the invention comprises additional improved means for securely connected a swing arm or arms 207 to the transverse linkage member (or drive tube) 209. FIGS. 27A-B show a single clamshell attachment bracket 1210, which is attached to two swing arms 207 and when mounted, fully encloses the transverse linkage member/drive tube 209. The clamshell halves may be solid, or may include ridges for strength. As shown in FIGS. 28-30, the two halves of the clamshell attachment bracket are hingedly connected 1214 along one side, and the drive tube 209 fits within cut-outs or openings 1216 (which match the corresponding shape and geometry, e.g., square or rectilinear) of the drive tube) on the inside of each of the halves, which when closed securely fit around the drive tube. The openings 1216 on the halves may be in any location, although a position near the hinged connection 1214 is preferred for strength and security. The other side (i.e., opposite the hinged connection) of the clamshell halves are configured to be releasably attached to each other, such as with snap-fit fittings, a bolt, or a rod or pin. In the embodiment shown, each side has tabs or slots 1222 with holes 1224 that correspondingly overlap when the bracket is closed, thereby allowing a pin or rod 1226 to be inserted therein to securely close the clamshell attachment bracket. The pin or rod may be secured by a bolt, cotter pin, or similar fastening means. The pin or rod also may be inserted through corresponding holes 1228 in the end of the swing arms, thereby providing a stronger connection.

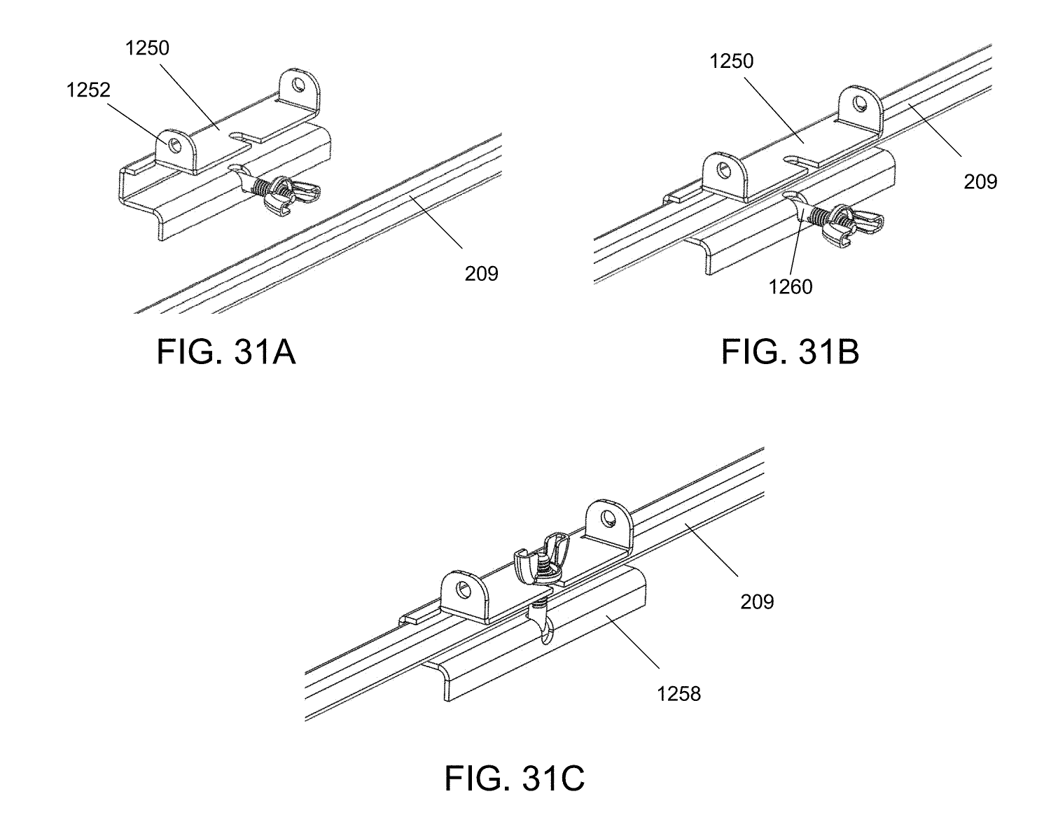

FIGS. 31A-C shows another form of attachment bracket 1250 for attaching two swing arms (which attach to the two upward extending tabs 1252 with holes on the upper part of the bracket). The bracket is fixed, and does not have movable parts itself, except for a securing bolt 1260 which moves from an open to closed position. The top, back side, and bottom of the bracket form an appropriate geometric configuration (e.g., square) to receive and hold a drive tube. A lower lip 1258 extend downward with a central slot to hold the securing bolt in various positions. In the open position shown in FIGS. 31A-B, the bolt is rotated or slid down and out of the way, and the bracket 1250 is placed over and fits around the drive tube. The bolt is then moved to an closed (upward) position, as seen in FIG. 31C and secured in place with a wing nut or similar means. The ends of the swing arms are attached to the tabs 1252 with bolts or similar mechanical fastening means.

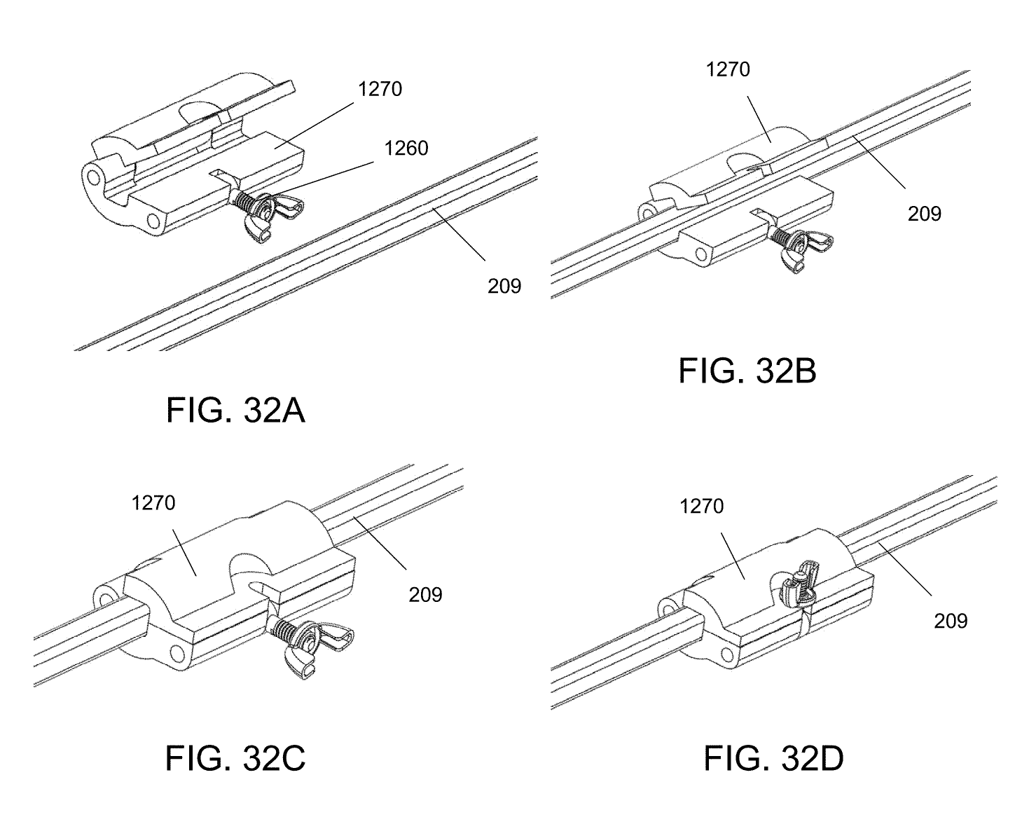

This movable security bolt 1260 mechanism may also be used with a form of clamshell attachment bracket 1270, as seen in FIGS. 32A-D. The clamshell is hingedly connected along the back edge, and opens to receive a drive tube 209 in a geometrically appropriate slot (or slots) on the inside. The clamshell is then closed and secured by rotating the securing bolt up and securing the bolt in place as described above.

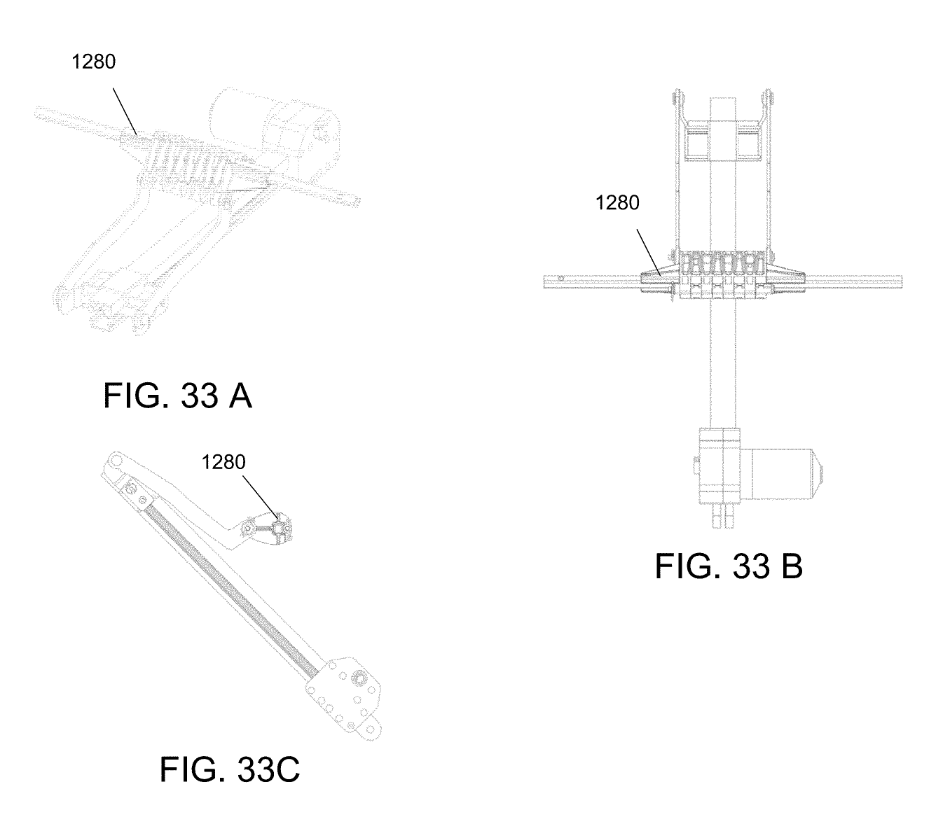

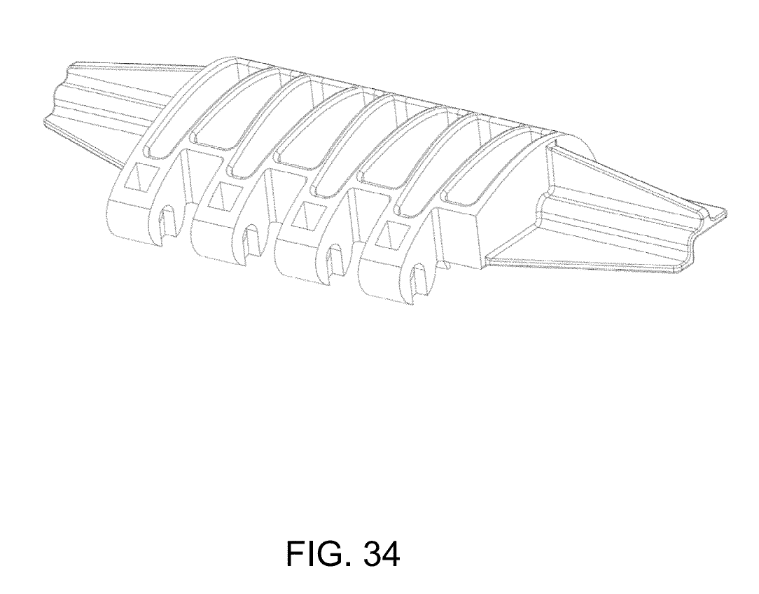

FIGS. 33A-C show an alternative form of the clamshell attachment bracket with bracket supports 1280 extending outward from one or both ends of the clamshell and encompassing the drive tube, thereby provide additional support, strength and security for the connection with the drive tube. The bracket supports may be ribbed. The bracket supports may be split into two parts on corresponding clamshells, as seen in FIG. 34.

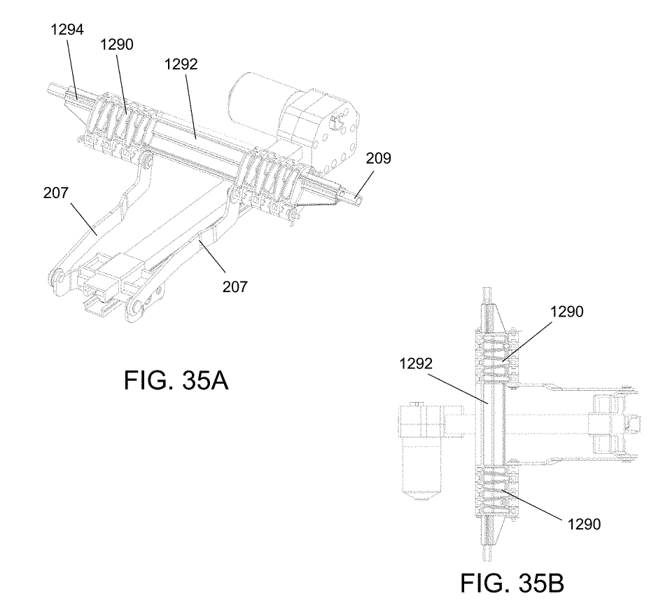

FIGS. 35A-B shows an alternative embodiment of the clamshell attachment bracket. In contrast to the swing arm being attached to the outside of a single clamshell, as shown in FIG. 28, in this embodiment each swing arm 207 attaches to one clamshell bracket 1290, and the clamshell bracket extends from the swing arm out along the drive tube 209 towards the recliner or scissor mechanism. The two clamshell brackets may be themselves attached by a center support 1292 extending therebetween (the center support may or may not encompass the drive tube). Each clamshell bracket also may comprise outside bracket supports 1294 extending outward from the outer ends, in a similar manner to that shown in FIGS. 33A-C. This attachment bracket may be formed as a single large bracket hingedly attached along one edge, with two separate attachments to the ends of the respective swing arms. The bracket, with supports, may for a portion of or substantially all of the length of the drive tube between the recliner/scissor mechanisms.

Accordingly, in several embodiments, the present invention comprises a linkage assembly for actuating reclining furniture actuation mechanisms, said linkage assembly comprising a motor assembly comprising a motor, a gear box housing, and a trolley driven by said motor in a bidirectional, linear motion; a first transverse drive tube with a first end and a second end, the first end attached to a first recliner mechanism and the second end attached to a second recliner mechanism; a first swing arm with a first end and a second end, the first end attached to the trolley and the second end attached to the first transverse drive tube by a first bracket; wherein the first bracket is removably affixed to the first transverse drive tube. The first bracket comprises a ridged clamshell with a top half with a front edge and a back edge, and a bottom half with a front edge and a back edge, wherein the top half and the bottom half are hingedly attached along respective front edges or back edges, and the top half and bottom half close together to fully enclose a portion of the first transverse drive tube. A drive tube channel extending from and through one end to the other end of the bracket is formed when the top half and bottom half close together. The drive tube channel is configured to securely hold and fully encompass or enclose the first transverse drive tube, wherein movement of the trolley causes movement of the swing arms, movement of the bracket, and thus rotation of the first drive tube.

The linkage assembly may comprise a second swing arm with a first end and a second end, the first end of the second swing arm attached to the trolley and the second end of the second swing arm attached to the first transverse drive tube by a second bracket. The first bracket comprises a right end and a left end, and the first swing arm and second swing arm may be attached to opposite ends of the first bracket. The first bracket also may comprise a first and a second (which may be ridged on the exterior for strength and stability) clamshell sections connected by a central support section, wherein the first swing arm is connected to the first ridged clamshell section and the second swing arm is attached to the second ridged clamshell section. The clamshell sections are those portions of the bracket where one side is hinged, and the other side forms the releasable connection (and may be where the swing arms are attached, typically pivotally attached).

The first bracket may further comprise one or more lateral support sections extending along the drive tube from one or both ends of the bracket. These lateral support sections may encompass and enclose the sections of the drive tube along which they extend.

The first bracket also may comprises a fixed form, integrated bracket (i.e., without halves), with a cross-section configured to securely hold the first transverse drive tube (e.g., rectilinear to hold a rectilinear cross-section drive tube), and with an opening along a side configured to receive the first transverse drive tube. A bolt is movable in a slot in the first bracket between an open position and a closed position, wherein in the open position the first transverse drive tube can be received into the first bracket, and in the closed position the first transverse drive tube is securely held and encompasses/enclosed in the first bracket, wherein movement of the trolley causes rotation of the first drive tube (as described above).

The linkage assembly further comprises a slide rail to which the motor assembly is mounted and on which said trolley is driven, said slide rail comprising a first end and a second end, wherein said first end of the slide rail is attached to a reclining furniture first frame member by first and second fittings configured to be mutually connectable without tools or fasteners. The second end of the slide rail may be free, or may be attached to a reclining furniture second frame member by third and fourth fittings configured to be mutually connectable without tools or fasteners.

In further embodiments, the linkage assembly further comprises a second transverse linkage bar with a first end and a second end, the first end attached to the first recliner mechanism and the second end attached to the second recliner mechanism, wherein the motor assembly is hingedly connected to the second transverse linkage bar between the first end and second end of said second transverse linkage bar. The first drive tube and/or the second transverse linkage bar may be connected to the respective recliner mechanisms by self-latching mechanisms as described above.

In further embodiments, the present invention comprises a clamshell drive tube bracket, comprising a first half with an exterior side, interior side, right end, left end, attachment edge, and hinge edge; a second half with a first half with an exterior side, interior side, right end, left end, attachment edge, and hinge edge; wherein the first half and second half are hingedly attached along at least a portion of said respective hinge edges, and releasably attach along at least a portion of said respective attachment edges; and further wherein the interior of said first half or the interior of said second, or both, comprise a linear channel extending from the respective right end and left end, said linear channel configured to securely hold and encompass a drive tube placed therein. A plurality of support ridges (for strength, stability, and reduction of weight) may be located on the exterior of the first half, the exterior of the second half, or both. The bracket further may comprise a plurality of first tabs with holes along the attachment edge of the first half, and a plurality of second tabs with holes along the attachment edge of the second half, wherein the second tabs interweave with the first tabs so that the respective holes are aligned when the bracket is in a closed position. A rod or bar may be inserted and extend through the respective holes when aligned to secure the bracket in the closed position. The first half may comprise one or more first rectilinear cut-outs and the second half may comprise one or more second rectilinear cut-outs, said respective cut-outs meeting and forming the linear channel when the bracket in a closed position. The linear channel is rectilinear is cross-section when configured to securely hold and encompass a drive tube that is rectilinear in cross-section.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A linkage assembly for actuating reclining furniture actuation mechanisms, said linkage assembly comprising:
a motor assembly comprising a motor and a trolley driven by said motor in a bidirectional, linear motion;
a first transverse drive tube with a first end and a second end, the first end attached to a first recliner mechanism and the second end attached to a second recliner mechanism;
a first swing arm with a first end and a second end, the first end attached to the trolley and the second end attached to the first transverse drive tube by a first bracket;
wherein the first bracket is removably affixed to the first transverse drive tube.

2. The linkage assembly of claim 1, wherein the first bracket comprises a ridged clamshell with a top half with a front edge and a back edge, and a bottom half with a front edge and a back edge, wherein the top half and the bottom half are hingedly attached along respective front edges or back edges.

3. The linkage assembly of claim 2, wherein the top half and bottom half close together to fully enclose a portion of the first transverse drive tube.

4. The linkage assembly of claim 3, further comprising a drive tube channel formed when the top half and bottom half close together.

5. The linkage assembly of claim 4, wherein the drive tube channel is configured to securely hold the first transverse drive tube, wherein movement of the trolley causes rotation of the first drive tube.

6. The linkage assembly of claim 1, further comprising a second swing arm with a first end and a second end, the first end of the second swing arm attached to the trolley and the second end of the second swing arm attached to the first transverse drive tube by a second bracket.

7. The linkage assembly of claim 1, further comprising a second swing arm with a first end and a second end, the first end of the second swing arm attached to the trolley and the second end of the second swing arm attached to the first transverse drive tube by the first bracket.

8. The linkage assembly of claim 7, wherein the first bracket comprises a right end and a left end, and the first swing arm and second swing arm are attached to opposite ends of the first bracket.

9. The linkage assembly of claim 7, the first bracket comprising a first and a second ridged clamshell sections connected by a central support section, wherein the first swing arm is connected to the first ridged clamshell section and the second swing arm is attached to the second ridged clamshell section.

10. The linkage assembly of claim 9, the first bracket further comprising one or more lateral support sections extending along the drive tube.

11. The linkage assembly of claim 1, the first bracket further comprising one or more lateral supports extending along the drive tube from one or more ends of the first bracket.

12. The linkage assembly of claim 1, wherein the first bracket comprises a fixed bracket with a cross-section configured to securely hold the first transverse drive tube, and with an opening along a side configured to receive the first transverse drive tube.

13. The linkage assembly of claim 12, further comprising a bolt movable in a slot in the first bracket between an open position and a closed position, wherein in the open position the first transverse drive tube can be received into the first bracket, and in the closed position the first transverse drive tube is securely held in the first bracket, wherein movement of the trolley causes rotation of the first drive tube.

14. The linkage assembly of claim 1, further comprising a slide rail to which said motor assembly is mounted and on which said trolley is driven, said slide rail comprising a first end and a second end;
wherein said first end of the slide rail is attached to a reclining furniture first frame member by first and second fittings configured to be mutually connectable without tools or fasteners.

15. The linkage assembly of claim 14, wherein the second end of the slide rail is attached to a reclining furniture second frame member by third and fourth fittings configured to be mutually connectable without tools or fasteners.

16. The motor assembly of claim 1, wherein the first drive is connected to the respective recliner mechanisms by self-latching mechanisms.

17. The linkage assembly of claim 1, further comprising a second transverse linkage bar with a first end and a second end, the first end attached to the first recliner mechanism and the second end attached to the second recliner mechanism, wherein the motor assembly is hingedly connected to the second transverse linkage bar between the first end and second end of said second transverse linkage bar.

18. The linkage assembly of claim 1, the motor assembly further comprising a gear box housing.

19. A clamshell drive tube bracket, comprising:
a first half with an exterior side, interior side, right end, left end, attachment edge, and hinge edge;
a second half with a first half with an exterior side, interior side, right end, left end, attachment edge, and hinge edge;
wherein the first half and second half are hingedly attached along at least a portion of said respective hinge edges, and releasably attach along at least a portion of said respective attachment edges; and
further wherein the interior of said first half or the interior of said second, or both, comprise a linear channel extending between the respective right end and left end, said linear channel configured to securely hold and encompass a drive tube placed therein.

20. The clamshell drive tube bracket of claim 1, further comprising:
a plurality of support ridges on the exterior of the first half, the exterior of the second half, or both;
a plurality of first tabs with holes along the attachment edge of the first half;
a plurality of second tabs with holes along the attachment edge of the second half, wherein the second tabs interweave with the first tabs so that the respective holes are aligned when the bracket is in a closed position; and
a rod or bar configured to extend through the respective holes when aligned and secure the bracket in the closed position;
further wherein the first half comprises one or more first rectilinear cut-outs and the second half comprises one or more second rectilinear cut-outs, said respective cut-outs meeting and forming the linear channel when the bracket in a closed position, further wherein said linear channel is rectilinear is cross-section and is configured to securely hold and encompass a drive tube that is rectilinear in cross-section.
